(19) United States
(12) Patent Application Publication
(10) Pub. No.: US 2012/0073446 A1
(43) Pub. Date: Mar. 29, 2012

(54) BEVERAGE-MAKING APPARATUS

(76) Inventors: Marius HILCKMANN, Witten (DE); Christian Voigt, Xanten (DE)

(21) Appl. No.: 12/969,815

(22) Filed: Dec. 16, 2010

(30) Foreign Application Priority Data
Dec. 17, 2009 (DE) 102009059175.3

(51) Int. Cl. A47J 31/00

(52) U.S. Cl. 99/275

(57) ABSTRACT

In order to provide an electrical household appliance, in particular comprising an electronic control device for different control functions by activation of respective switching elements, as well as comprising an acoustic signal generator, wherein different acoustic signals being pleasant for the user can be generated, it is proposed that the signal generator is an electronic sound generator, by means of which sounds with different sound frequencies and/or amplitudes can be generated.

### FIELD OF THE INVENTION

The invention concerns an electrical household appliance, preferably a device for preparing beverages, in particular comprising an electronic control device for different control functions by activation of respective switching elements, as well as comprising an acoustic signal generator.

### BACKGROUND OF THE INVENTION

Prior art electrical household appliances, in particular devices for preparing beverages, comprise control arrangements, by means of which control functions and program functions can be entered mechanically and/or electronically by the user. When operating microcomputer-supported devices, communication with a microcomputer usually takes place by digital inputs or outputs. For the selection and activation of a control function or of a program function, the user operates a corresponding selector switch, pushbutton switch or electronically working touch, film or key switches. Further it is known from prior art to illustrate corresponding control functions or device functions by visual or audible indication, in order to announce the selected function. Common acoustic devices are buzzers that can emit different sounds. It is also known to acoustically display corresponding control functions such that the acoustic display occurs by means of a speech synthesizer and a loudspeaker, so that the selected control function is reproduced by voice.

### OBJECT OF THE INVENTION

Based on this prior art, it is the object of the invention to provide a household appliance of the species mentioned above, wherein different acoustic signals being pleasant for the user can be generated.

### SUMMARY AND SPECIFIC DESCRIPTION OF THE INVENTION

For achieving this object, the invention proposes that the signal generator is an electronic sound generator, by means of which sounds with different sound frequencies and/or amplitudes can be generated.

Preferably, the signal generator is an electronic sound generator, by means of which sounds with different pitches and/or different sound waveforms and/or volumes or volume envelopes can be generated.

Further, it is preferred that different acoustic signals are assigned to different control functions, the acoustic signals being stored for instance in an electronic memory as electronic information, and that the electronic information in the form of different acoustic signals can be activated by the switching elements that are controlled by the control functions.

It may also be preferred that by means of stored waveforms, the signal generator is suited for a voice information statement.

In the solution according to the invention, a sound generator is used for the acoustic signal generation, which is capable to simultaneously reproduce sounds of different pitches and/or different waveforms and/or volumes and volume envelopes. Thereby, a very pleasant hearing impression can be generated for the user. Further, signals can clearly be distinguished to each other, in order to facilitate the assignment of the signal or of the sequence of sounds or of the tone to the specific information to be transmitted. For an improvement of the invention, the sound generator is extended such that also text in the form of voice can be generated, in particular by means of recorded is waveforms.

The invention can in particular be employed in devices for preparing beverages in manifold ways.

It is preferred that the sound generator generates different sound waves, which are reproduced simultaneously in a superimposed manner as polyphonic sounds.

Conventional buzzers can reproduce sounds with different frequencies, but not simultaneously as polyphonic sounds. By the design according to the invention, different sound waves can be superimposed and reproduced as a polyphonic sound pattern.

We claim:

1. An electrical household appliance, preferably a device for preparing beverages, in particular comprising an electronic control device for different control functions by activation of respective switching elements, as well as comprising an acoustic signal generator, wherein the signal generator is an electronic sound generator, by means of which sounds with different sound frequencies and/or amplitudes can be generated.

2. The electrical household appliance, in particular according to claim 1, wherein the signal generator is an electronic sound generator, by means of which sounds with different pitches and/or different sound waveforms and/or volumes or volume envelopes can be generated.

3. The electrical household appliance according to claim 1, wherein different acoustic signals are assigned to different control functions, the acoustic signals being stored for instance in an electronic memory as electronic information, and that the electronic information in the form of different acoustic signals can be activated by the switching elements that are controlled by the control functions.

4. The electrical household appliance according to claim 1, wherein by means of stored waveforms, the signal generator is suited for a voice information statement.

5. The electrical household appliance according to claim 1, wherein the sound generator generates different sound waves, which are reproduced simultaneously in a superimposed manner as polyphonic sounds.
